(19) United States
(12) Patent Application Publication
(10) Pub. No.: US 2023/0411783 A1
(43) Pub. Date: Dec. 21, 2023

(54) SAFE BATTERY CHARGING STATION MOUNTED FIRE EXTINGUISHING FACILITATING APPARATUS

(71) Applicant: Yarok Advanced Solutions Ltd., Tel Aviv (IL)

(72) Inventors: David Wolf, Givatayim (IL); Ari Eyal Maor, Tel-Aviv (IL)

(21) Appl. No.: 17/962,356

(22) Filed: Oct. 7, 2022

(30) Foreign Application Priority Data
Jun. 19, 2022 (IL) 294100

(51) Int. Cl. H01M 50/383; H01M 50/204

(52) U.S. Cl. CPC H01M 50/383; H01M 2220/20; H01M 50/204

(57) ABSTRACT

Charging station mounted fire extinguishing facilitating apparatus, comprising a plurality of spaced interconnected partitions fixedly mounted at a charging station that define an interior volume within which an electric bicycle battery is introducible and rechargeable, and one or more peripheral cavities in communication with the interior volume, within each of the cavities a sealed heat sensitive package containing a flowable fire extinguishing material is receivable, wherein the heat sensitive package is confined by the partitions defining the cavity within which it is received so as to remain in positional relation with the interior volume and is configured to be sufficiently deformed so as to become perforated in at least one package region during exposure to a predetermined fire-induced temperature when the battery is inflamed, thereby allowing the contained fire extinguishing material to be discharged from the package via a perforation at the at least one package region, to flow into the interior volume, and to extinguish the fire.

### CROSS-REFERENCE TO RELATED APPLICATION(S)

This application claims the benefit and foreign priority to Israeli Application No. 294100, filed Jun. 19, 2022, the entirety of which is hereby incorporated by reference.

### FIELD OF THE INVENTION

The present invention relates to the field of fire extinguishing apparatus. More particularly, the invention relates to fire extinguishing facilitating apparatus mounted within a charging station.

### BACKGROUND

Electric bicycles, which are equipped with a motor powered propulsion system to assist users while pedaling with muscular force, are gaining ongoing popularity by virtue of the significantly reduced operational costs and carbon emissions relative to automobiles. In addition, rechargeable lithium-ion batteries used to power the electric propulsion system of electric bicycles have undergone much development, leading to smaller, more efficient, and cheaper batteries.

In order to ensure that an electric bicycle will be readily usable, the user has to recharge the battery on a regular basis, for example after returning home at the end of a workday. Many shopping malls deploy charging stations for the benefit of bicycle riding customers, by which a bicycle battery can be recharged when the customer is shopping.

One charging station of importance for shoppers or users of public buildings is configured as an array of rentable and lockable cabinets, each of which is provided with its own power supply. The battery is able to be easily detached from the bicycle and coupled to the power supply socket of a rented cabinet, reassuring the user that the cabinet is theft resistant and the battery is therefore protected while being charged.

However, lithium-ion batteries contain a flammable liquid electrolyte, and if they are damaged or incorrectly charged, the electrolyte is liable to be pressurized and explode to produce a fire. When short-circuited caused for example by manufacturing flaws, a cracked battery case through which oxygen and moisture infiltrate to oxidize the lithium components, and a faulty charger, the battery cell overheats and often leads to a fire that is accompanied with toxic smoke.

It is an object of the present invention to provide a lockable cabinet of a safe charging station with fire extinguishing facilitating apparatus to prevent a battery caused fire generated in one cabinet from spreading outwardly from the cabinet, for example from spreading to another cabinet.

It is an additional object of the present invention to provide fire extinguishing facilitating apparatus of sufficiently small size to allow unrestricted introduction of the bicycle battery into the lockable cabinet, while minimizing the external dimensions of each cabinet to maintain the economic viability of the charging station.

Other objects and advantages of the invention will become apparent as the description proceeds.

### BRIEF SUMMARY

Charging station mounted fire extinguishing facilitating apparatus comprises a plurality of spaced interconnected partitions fixedly mounted at a charging station that define an interior volume within which an electric bicycle battery is introducible and rechargeable, and one or more peripheral cavities in communication with said interior volume, within each of said cavities a sealed heat sensitive package containing a flowable fire extinguishing material is receivable, wherein said heat sensitive package is confined by the partitions defining the cavity within which it is received so as to remain in positional relation with said interior volume and is configured to be sufficiently deformed so as to become perforated in at least one package region during exposure to a predetermined fire-induced temperature when said battery is inflamed, thereby allowing the contained fire extinguishing material to be discharged from said package via a perforation at said at least one package region, to flow into said interior volume, and to extinguish the fire.

In one aspect, the plurality of partitions are mounted within an enclosed charging station and are resistant to the fire-induced temperature. The enclosed charging station may be configured as a lockable cabinet made of solid steel construction, or as an array of the lockable cabinets.

In one aspect, one or more of the partitions is of openwork construction defining a plurality of openings through which the fire extinguishing material is able to flow from one of the peripheral cavities to the interior volume.

In one aspect, the plurality of interconnected partitions are configured as a main cage made at least partially of openwork construction and that is mounted onto one or more cabinet fixtures.

In one aspect, the apparatus further comprises an upper cage component mounted onto the one or more cabinet fixtures above the main cage so as to be in communication with the interior volume and defining another package-receivable cavity.

In one aspect, the apparatus further comprises a lower cage component securely positioned on top of a cabinet bottom surface below the main cage so as to be in communication with the interior volume via a bottom cage section of the main cage and defining another package-receivable cavity.

### BRIEF DESCRIPTION OF THE SEVERAL VIEWS OF THE DRAWINGS

FIG. 1 is a perspective view from the front of an embodiment of a charging station.

FIG. 2 is an exploded view of the charging station of FIG. 1.

FIG. 3 is a perspective view from the front of another embodiment of a charging station.

FIG. 4 is a perspective view from the rear of another embodiment of a charging station.

FIG. 5 is a perspective view from the front of a cage mountable within the charging station of FIG. 4.

FIG. 6 is a perspective view from the rear of a cage mountable within the charging station of FIG. 4.

FIG. 7 is a perspective view of a rechargeable battery for an electric bicycle that is insertable within the cage of FIG. 5.

FIG. 8 is a perspective view from the top and rear of an upper cage component.

FIG. 9 is an exploded view of the charging station of FIG. 4.

FIG. 10 is a perspective view from the top of another embodiment of a cage.

### DETAILED DESCRIPTION

The fire extinguishing facilitating apparatus is internally mounted within a theft-resistant cabinet and is configured with one or more peripheral cavities within each of which a heat sensitive package is receivable. The heat sensitive package contains a fire extinguishing material, so that upon an outbreak of a fire within a cabinet, the fire-induced temperature exceeds the melting point of the heat sensitive package. The package bursts since its structural strength is weakened, allowing exposure of the discharged fire extinguishing material to the burning battery that causes the fire to become extinguished.

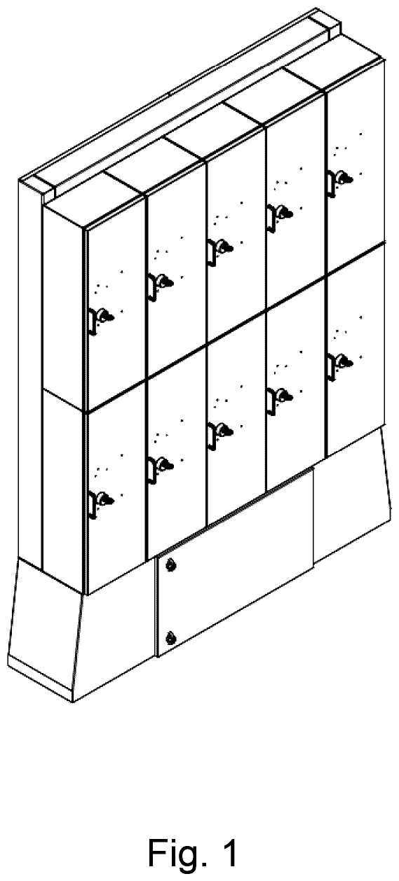

FIG. 1 illustrates an exemplary charging station 10 that comprises an array of interconnected horizontally and vertically aligned theft-resistant cabinets 5, within each cabinet 5 a corresponding bicycle battery is independently insertable and chargeable. The battery being charged is protected by a lock 4 fitted in an outwardly facing pivotal door 6. Lock 4 is able to be locked and unlocked whenever desired, generally after the corresponding cabinet 5 has been rented or permitted to be used.

Each wall and door of a cabinet 5 may be of sturdy solid steel construction, such as galvanized steel, which may have a thickness ranging from 0.5-4 mm, e.g., 0.9 mm. Charging station has a base 2 that is able to be anchored to the underlying floor and to be connected to a bottom row of the array of cabinets. A vertical mounting member 7 securely attached to the closed rear wall of each cabinet 5 upwardly extends from base 2 and is used for mounting onto the wall of a building or for supporting the charging station when deployed at an open area which may be outdoors. The power supply provided within each cabinet 5 may be electrically connected via a corresponding secondary cable extending through mounting member 7 and base 2 to an underground main cable, possibly by means of a junction box housed within base 2.

If so desired, the array of interconnected theft-resistant cabinets 5 connected to base 2 and mounting member 7 need not be horizontally and vertically aligned. Alternatively, the charging station is configured with a single cabinet 5.

The array may also comprise heat insulating sheets deployed between adjacent cabinets, in order to prevent overheating of neighboring cabinets, in case of battery inflammation in a specific cabinet. This allows replacing only the damaged cabinet without further damage to the surrounding cabinets.

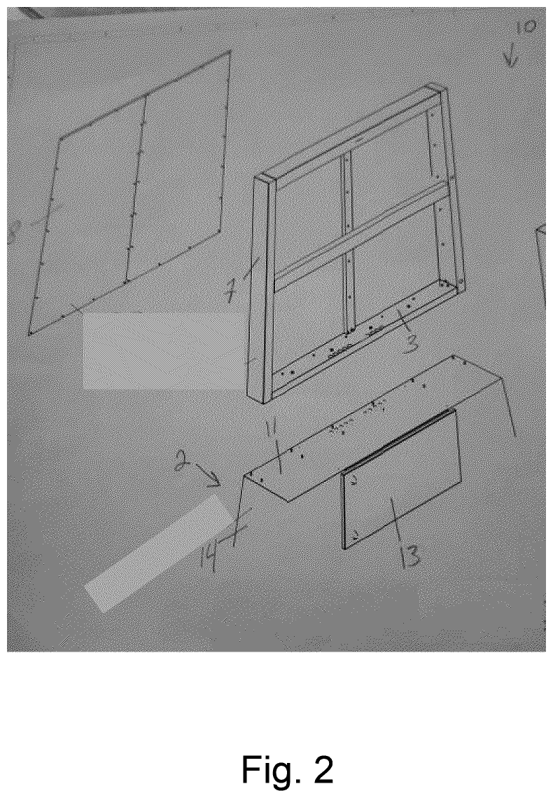

FIG. 2 illustrates an exploded view of charging station 10. Mounting member 7 is shown to be configured as a frame member with a plurality of open regions and is connected to a pair of rear mounting plates 8. Base 2 is shown to be hollow, being configured with a horizontal platform 11 to which is connected the bottom support member 3 of mounting member 7 and the bottom wall of the bottom row of the array of cabinets, a rear surface 14 substantially perpendicular to platform 11, and front access panel 13, which, when removed, allows access to the junction box or to other electrical connections.

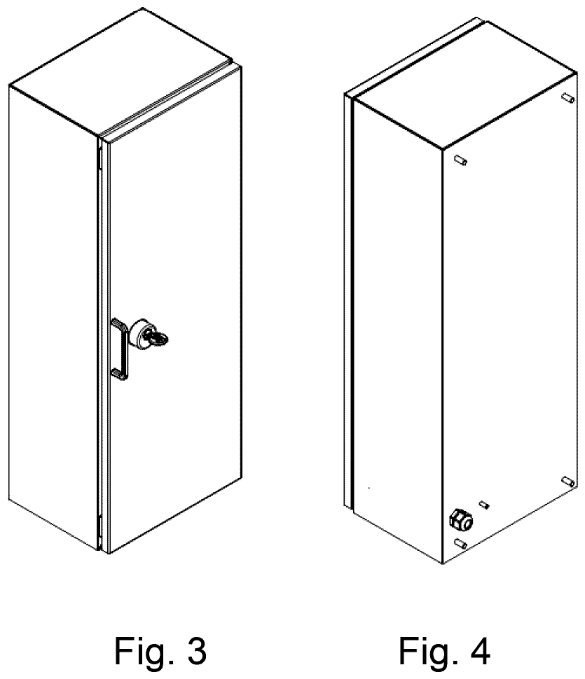

FIGS. 3 and 4 illustrate a cabinet 5 positioned at the end of a row of the array. While one side wall 16 of this cabinet is continuous and uncompromised, the other side wall 17 is configured with a tubular cable enclosure 19 that slightly protrudes therefrom at a lower end and that is received within a complementary cavity formed in the side wall 16 of the adjacent cabinet. Exemplary dimensions of cabinet 5 are a height of 80 cm, a width of 30 cm and a depth of 22.3 cm.

Lock 4 may be any cabinet-mounted anti-theft lock well known to those skilled in the art, such as a key-actuated lock and an electronic lock and may be configured with a bolt that is secured to the top and bottom of the cabinet. An insulation layer 18, for example made of expandable graphite, may be applied to the inner surface of door 6. When exposed to fire, insulation layer 18 is designed to expand, for example at least 11 times its original thickness, to prevent both inward infiltration of oxygen from the surroundings and outward passage from the interior of the cabinet of the flame, smoke, and gas.

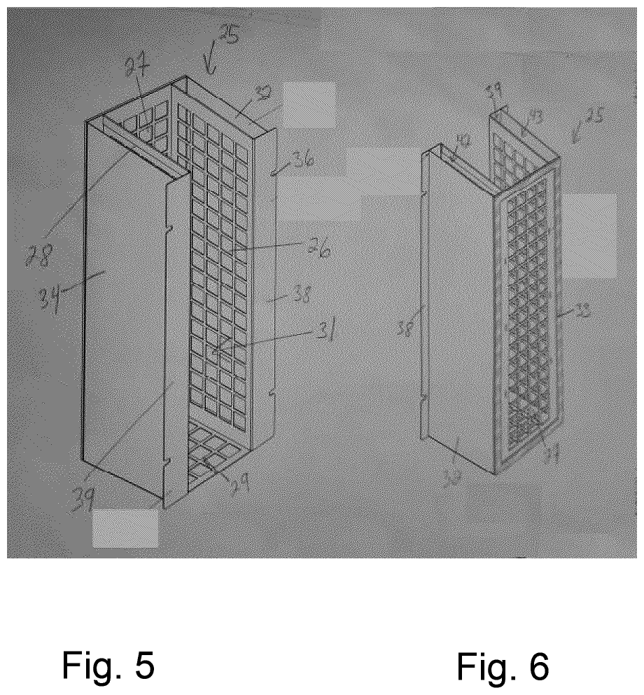

FIGS. 5 and 6 illustrate a cage 25 for receiving one or more heat sensitive packages, each containing a fire extinguishing material, and for separating the packages from a volume within which an electric bicycle battery is introducible and rechargeable. Although cage 25 is shown to be rectilinear and to have a height that is significantly greater than its width and depth, the cage may be shaped in other ways as well.

Cage 25 is positioned within a cabinet and is connected to a cabinet fixture by flanges 38 and 39, which are formed with vertically spaced mounting holes 36. One or more sides or portions of cage 25 may be separated from the cabinet within which it is mounted.

In this embodiment, cage 25 is U-shaped, being configured with a right section 26, a rear section 27, a left section 28, and a bottom section 29 of metallic openwork construction that are interconnected to define an interior volume 31 within which the battery is insertable and facing the cabinet door. The openwork construction is shown to be formed by an arrangement of intersecting horizontal and vertical borders to define a plurality of square openings through which fire extinguishing material is able to flow, but any other openwork construction such as of diamond-shaped openings is also within the scope of the invention. Parallel to right section 26 and left section 28 are ungapped cage walls 32 and 34, respectively, of the same height.

Rear section 27 is provided with a solid ungapped peripheral element 33 surrounding the plurality of openings, to which are connected, for example weldingly connected, right openwork section 26 and ungapped wall 32 at one side and left openwork section 28 and ungapped wall 34 at the other side. Two flanges 38 and 39 parallel to rear section 27 extend vertically from bottom openwork section 29 and laterally in opposite directions from the front edge of the corresponding openwork section and ungapped wall delimiting interior volume 31, flange 38 being connected to right openwork section 26 and ungapped wall 32 and flange 39 being connected to left openwork section 28 and ungapped wall 34.

In this fashion, two cavities 42 and 43 adapted to receive a corresponding heat sensitive package are defined. Cavity 42 is defined by flange 38, right openwork section 26 ungapped wall 32, and rear section peripheral element 33. Cavity 43 is defined by flange 39, left openwork section 28, ungapped wall 34, and rear section peripheral element 33.

It will be appreciated that a cage may be configured with any other number of package-receivable cavities, insofar as the liquid or gel fire extinguishing material, capable of being released from the package contained in each of the cavities when exposed to a fire, is in discharge range of interior volume 31 so as to be capable of extinguishing the battery caused fire.

In addition to constituting the means by which the discharged fire extinguishing material is able to communicate with the cage interior volume 31, the various openings of sections 26-29 serve to dissipate the intense heat of approximately 1300° C. that is generated when a bicycle battery is burning. In an experiment conducted by the Applicant, the temperature of each cabinet wall adjacent to the metallic openwork cage section that absorbed the heat of a burning battery was surprisingly able to be reduced from 1300° C. to 250° C. Thus, the presence of cage 25 helps to minimize, or altogether eliminate, fire resulting damage to a cabinet wall when an electric bicycle battery positioned therewithin is burning, and also prevents the fire from spreading to an adjacent cabinet.

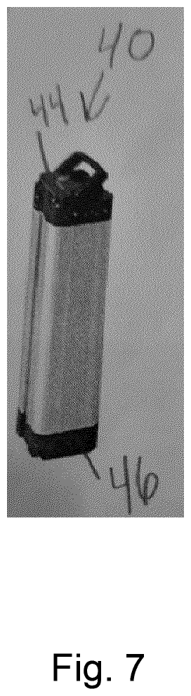

Cage 25 is dimensioned to receive a typical electrical bicycle battery, such as battery 40 shown in FIG. 7, with minimal clearance to allow the battery to become supported by the bottom section without necessarily contacting the other openwork sections and to allow the battery to be charged within the cabinet. A 12V lithium-ion seat tube battery 40 may have a height of 152 mm, a width of 99 mm, and a depth of 98 mm. This battery has a central metallic case 42, e.g., made of aluminium, and end plastic housing elements 44 and 46 in which electronic and charging apparatus is housed. Both the cage and cabinet, or only the cage, may be differently dimensioned if a larger sized battery is anticipated to be charged. During an unforeseen malfunction of battery 40 during charging, the end plastic housing elements 44 and 46 are the first battery elements to become damaged when the battery becomes overheated, and a fire results.

The fire extinguishing material is able to be released from each package received in cavities 42 and 43 if the battery 40 being recharged within cage interior volume 31 becomes overheated, and a fire results. The released fire extinguishing material, which may be for example a gel or a liquid, passes through the openings of the side cage sections, contacting the burning battery and causing the fire to be extinguished.

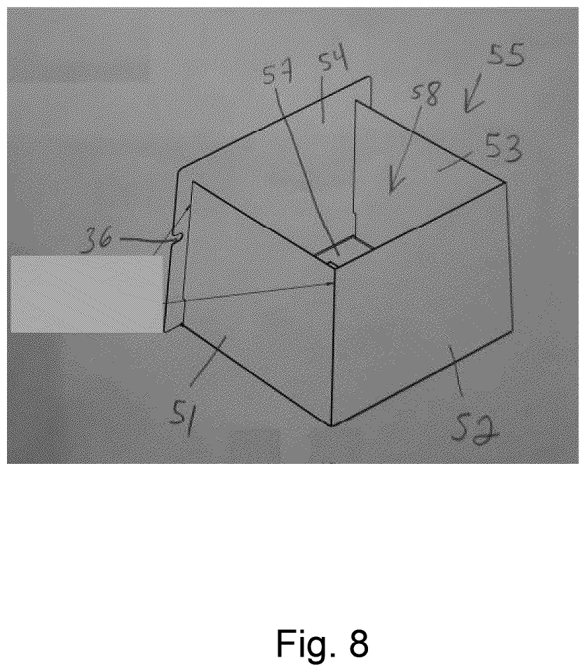

As upper end plastic housing element 44 is usually the first battery element to become inflamed, the mounting of upper cage component 55 shown in FIG. 8 provides an additional package-receiving cavity from which heat extinguishing material is able to be discharged directly on top of upper end plastic housing element 44.

Upper cage component 55 positionable above cage 25 is shown to be a rectilinear component, although other configurations are also within the scope of the invention. Mutually perpendicular ungapped walls 51-54 welded to, and extending upwardly from a corresponding edge of, horizontal openwork section 57 define package-receiving cavity 58. Wall 54 extending laterally beyond walls 51 and 53 is formed with mounting holes 36 for mounting onto a cabinet fixture.

According to one embodiment, the lower openwork construction that is formed at the bottom of the upper cage component 55 (to define a plurality of square openings through which fire extinguishing material is able to flow) has wide margins, such that in case of fire, the heat extinguishing material will be discharged directly on top of upper end plastic housing element 44, without allowing material to flow down from the circumference.

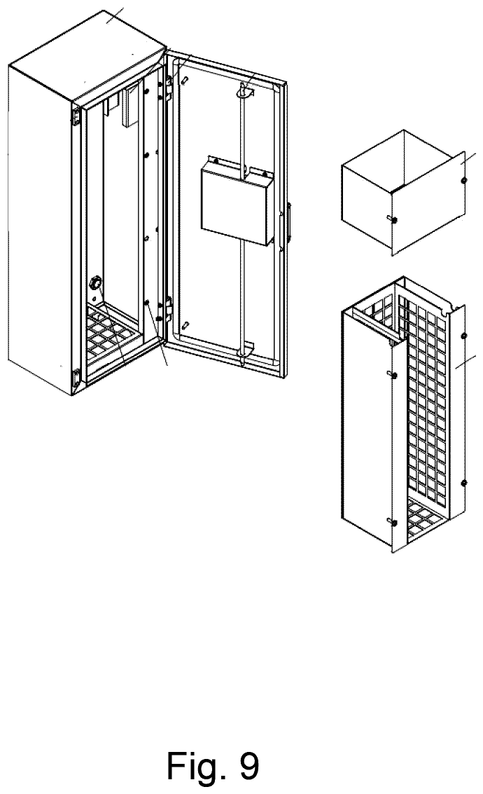

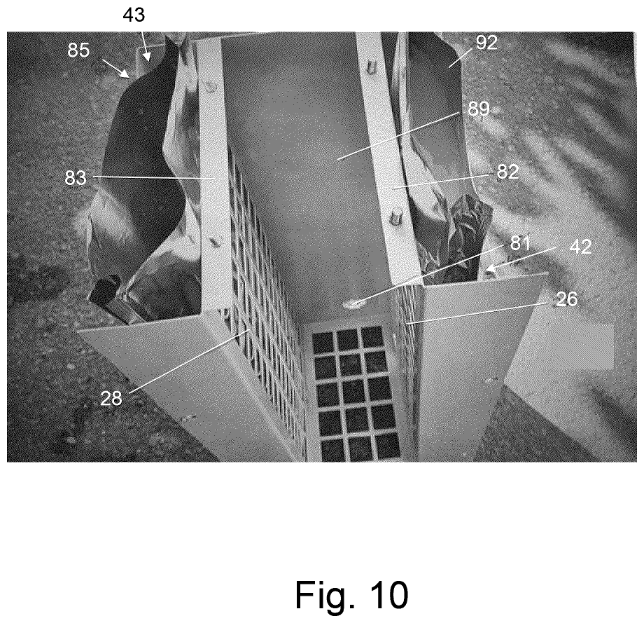

FIG. 9 is an exploded view of a single-cabinet charging station 10A, showing cabinet 5 when its door 6 is opened to illustrate some of its internal structure and both cage 25 and upper cage component 55 are positioned outwardly from the cabinet.

Two thin vertically oriented mounts 62 vertically extending along the entire height of cabinet are positioned at each lateral side of the forward end of the cabinet interior, one mount being positioned adjacent to the hinges 64 of door 6 and another adjacent to side wall 16. The lateral spacing between the two mounts 62 is sufficient to allow four lower mounting holes 66 formed therein to be aligned with corresponding mounting holes of flanges 38 and 39 of cage 25 and two other upper mounting holes formed in the mounts 62 to be aligned with corresponding mounting holes of wall 54 of upper cage component 55. When both cage 25 and upper cage component 55 are mounted onto mounts 62, upper cage component 55 is generally spaced from cage 25, providing the user with sufficient available volume within the cage interior to charge the battery.

One charger configuration is shown. Two charger holder components 68 and 69 are positioned within the cabinet interior close to cabinet roof 12. The AC input cable extends through cable enclosure 19 and then upwardly along side-wall 17 to the charger held by components 68 and 69. The DC output cable extends from the charger, passing through the clearance between rear section 27 (FIG. 5) and cabinet rear wall 9 and then through one of the openings of the rear section into the cage interior.

The DC output cable is terminated with a corresponding plug for each battery type. For example, some batteries generate an output DC voltage of 24 V, while other batteries generate an output DC voltage of 48 V. In case of an array of cabinets, a software application that may be downloaded to the smartphone of the user will ask the user to input his battery model. This application will provide an indication to the user which cabinet has a plug that mates the type and voltage of the battery to be charged.

When cage 25 is mounted, bottom cage section 29 is spaced from cabinet bottom surface 15. To ensure that the lower end plastic housing element of the battery will be suitably exposed to fire extinguishing material when needed, lower cage component 75 may be employed. Lower cage component 75, which has a horizontal openwork section 77 and a plurality of mutually perpendicular short supporting walls including wall 79 welded to, and extending downwardly from a corresponding edge of, horizontal openwork section 77 to define a package-receiving cavity, is securely positioned on top of cabinet bottom surface 15. Horizontal openwork section 77 is accordingly set in close proximity to, or in abutting relation with, bottom cage section 29. Suitable fire extinguishing material to be received in the package-receiving cavity of lower cage component 75 is gel. During occurrence of a battery caused fire, the gel is able to be conveniently discharged from the cavity of lower cage component 75 and contact the inflamed lower end plastic housing element.

Another embodiment of a cage 85 is illustrated in FIG. 10. Cage 85 is similar to cage 25 of FIG. 4 with the exception of the ungapped rear wall 87 in place of the rear cage section that delimits the interior cage volume and the laterally spaced upper flanges 82 and 83 that slightly extend inwardly from the upper edge of right cage section 26 and left cage section 28, respectively, into the interior cage volume. Upper flanges 82 and 83 are used to mount cage 85 onto the cabinet roof in such a way that a clearance is formed between each cabinet wall and a corresponding cage surface. An aperture 81, through which the DC output cable extending from the charger is introducible, is formed in rear wall 87, generally at the bottom thereof.

According to one embodiment, hinges 64 of door 6 may be internal hinges. In addition, in order to resist and overcome the thrust that is generated within the cabinet 5 when battery 40 is inflamed, several magnet bars may be mounted along the outer lintel of door 6.

A heat sensitive package 92 is shown to be received in each of the two cavities 42 and 43. Package 92 is made of a material that is resistant to temperatures of up to approximately 100° C. but structurally fails such as by melting when exposed to a fire-induced temperature of approximately 1300° C. Upon failure of the package, the contained heat extinguishing material is discharged into the interior cage volume to extinguish the battery caused fire. Package 92 may be made of metalized polyethylene or metalized polyester and have a thickness ranging from 3-7 mm.

The fire extinguishing material that is introduced into package 92 and that is able to flow towards the battery caused fire may be a gel which is imparted with various fire extinguishing properties such as temperature reduction and smoke toxicity suppression. The gel may be made of a superabsorbent polymer such as an adherent and crosslinked, water-insoluble and water-swellable polymer. The package is sealed following introduction of the fire extinguishing material, whether a gel or a liquid, thereinto.

While some embodiments of the invention have been described by way of illustration, it will be apparent that the invention can be carried out with many modifications, variations, and adaptations, and with the use of numerous equivalents or alternative solutions that are within the scope of persons skilled in the art, without exceeding the scope of the claims.

All of the U.S. patents, U.S. patent application publications, U.S. patent applications, foreign patents, foreign patent applications, and non-patent publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. Charging station mounted fire extinguishing facilitating apparatus, comprising:
a plurality of spaced interconnected partitions fixedly mounted at a charging station that define an interior volume within which an electric bicycle battery is introducible and rechargeable, and
one or more peripheral cavities in communication with said interior volume, within each of said cavities a sealed heat sensitive package containing a flowable fire extinguishing material is receivable,
wherein said heat sensitive package is confined by the partitions defining the cavity within which it is received so as to remain in positional relation with said interior volume and is configured to be sufficiently deformed so as to become perforated in at least one package region during exposure to a predetermined fire-induced temperature when said battery is inflamed, thereby allowing the contained fire extinguishing material to be discharged from said package via a perforation at said at least one package region, to flow into said interior volume, and to extinguish the fire.

2. The apparatus according to claim 1, wherein the plurality of partitions are mounted within an enclosed charging station and are resistant to the fire-induced temperature.

3. The apparatus according to claim 2, wherein the enclosed charging station is configured as a lockable cabinet made of solid steel construction.

4. The apparatus according to claim 3, wherein the enclosed charging station is configured as an array of the lockable cabinets.

5. The apparatus according to claim 2, wherein one or more of the partitions is of openwork construction defining a plurality of openings through which the fire extinguishing material is able to flow from one of the peripheral cavities to the interior volume.

6. The apparatus according to claim 3, wherein the plurality of interconnected partitions are configured as a main cage made at least partially of openwork construction and that is mounted onto one or more cabinet fixtures.

7. The apparatus according to claim 6, further comprising an upper cage component mounted onto the one or more cabinet fixtures above the main cage so as to be in communication with the interior volume and defining another package-receivable cavity.

8. The apparatus according to claim 6, further comprising a lower cage component securely positioned on top of a cabinet bottom surface below the main cage so as to be in communication with the interior volume via a bottom cage section of the main cage and defining another package-receivable cavity.
